(19) United States
(12) Patent Application Publication
(10) Pub. No.: US 2011/0169401 A1
(43) Pub. Date: Jul. 14, 2011

(54) PLASMA DISPLAY PANEL

(76) Inventors: Shinsuke Yoshida, Hyogo (JP); Akira Kawase, Hyogo (JP); Kazuhiro Morioka, Kyoto (JP); Naoto Haze, Osaka (JP); Yoshiyuki Ota, Osaka (JP); Morio Fujitani, Osaka (JP); Hiroshi Ito, Osaka (JP); Tatsuo Mifune, Osaka (JP)

(21) Appl. No.: 12/990,363

(22) PCT Filed: Jun. 23, 2010
(86) PCT No.: PCT/JP2010/004166

§ 371 Date: Oct. 29, 2010

(30) Foreign Application Priority Data
Jun. 23, 2009 (JP) 2009-148314
Jun. 23, 2009 (JP) 2009-148315
Jun. 23, 2009 (JP) 2009-148316
Jul. 6, 2009 (JP) 2009-159522

(51) Int. Cl. H01J 17/02

(52) U.S. Cl. 313/581

(57) ABSTRACT

The PDP has front plate and a rear plate. Front plate and the rear plate are oppositely disposed and sealed at the peripheries. Front plate has display electrode and dielectric layer. Dielectric layer contains an oxide of a divalent element, an oxide of a trivalent element, and an oxide of a tetravalent element. The total content of the oxide of a trivalent element and the oxide of a tetravalent element is larger by weight than the content of the oxide of a divalent element.

### TECHNICAL FIELD

The present invention relates to a plasma display panel employed for a display device.

### BACKGROUND ART

In a plasma display panel (hereinafter referred to as PDP), to obtain conductivity, a silver electrode is employed for a bus electrode that forms a display electrode. A dielectric layer, which covers the bus electrode, contains low-melting-point glass having lead oxide as a main component. In recent years, from the viewpoint of environmental protection, a lead-free dielectric layer has been employed (see patent literature 1, for example).

If a PDP is subject to an impact or a load, a crack can occur in a component of the PDP. In terms of improvement in reliability, the PDP has to have a structure capable of preventing crack spreading. Such an impact or a load on the PDP can cause a collision between the dielectric layer on the front plate and the barrier ribs on the rear plate, by which a tiny crack can occur in the dielectric layer and it can develop into serious damage.

### PATENT LITERATURE

patent literature 1: Japanese Unexamined Patent Application Publication No. 2003-128430

### SUMMARY OF THE INVENTION

The PDP has a front plate and a rear plate. The two plates are disposed opposite to each other and sealed at the peripheries. The front plate has a display electrode and a dielectric layer. The dielectric layer contains an oxide of a divalent element, an oxide of a trivalent element, and an oxide of a tetravalent element. The content ratio by weight of the oxides above is determined so that the total content of the oxide of a trivalent element and the oxide of a tetravalent element is greater than the content of the oxide of a divalent element.

The technique disclosed here addresses the problem described earlier and provides an environment-friendly PDP with high reliability.

### BRIEF DESCRIPTION OF THE DRAWINGS

FIG. 1 is a perspective view showing the structure of a PDP in accordance with an exemplary embodiment.

FIG. 2 is a sectional view showing the structure of the front plate of a PDP in accordance with the exemplary embodiment.

### DETAILED DESCRIPTION OF THE PREFERRED EMBODIMENTS

1. General Structure of PDP 1

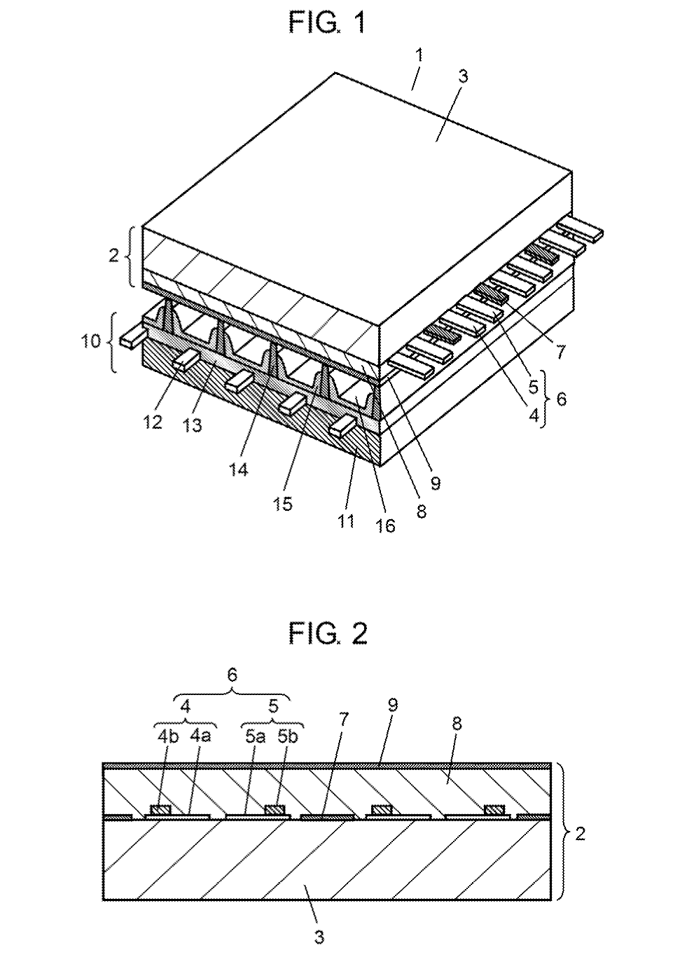

Plasma display panel 1 (hereinafter, PDP 1) of the present embodiment is an AC surface discharge-type PDP. In PDP 1 shown in FIG. 1, front plate 2 and rear plate 10 are oppositely disposed. Front plate 2 has front glass substrate 3, and similarly, rear plate 10 has rear glass substrate 11. Front plate 2 and rear plate 10 are hermetically sealed at the peripheries with sealing material made of, for example, glass frit. Discharge space 16 formed inside PDP 1 is filled with discharge gas, such as Ne and Xe, with a pressure of 55 kPa-80 kPa.

On front glass substrate 3, a plurality of display electrodes 6—each of which is a strip-shaped pair of scan electrode 4 and sustain electrode 5—and a plurality of black stripes (light-shielding layers) 7 are disposed in parallel with each other. Further, display electrodes 6 and light-shielding layers 7 are covered with dielectric layer 8 that functions as a capacitor. On the surface of dielectric layer 8, protective layer 9 mainly made of magnesium oxide (MgO) is formed.

On rear glass substrate 11, a plurality of strip-shaped address electrodes 12 are disposed in parallel so as to be orthogonal to display electrodes 6 on front plate 2. Further, dielectric base layer 13 is formed so as to cover address electrodes 12. On dielectric base layer 13, barrier ribs 14 with a predetermined height are formed and partitions discharge space 16. Phosphor layers 15, each of which differently emits lights of red, blue, and green by excitation with ultraviolet light, are disposed in a regular order between barrier ribs 14.

A discharge cell is formed at an intersection of display electrode 6 and address electrode 12. A combination of the discharge cells each of which has phosphor layer 15 being responsible for emitting red, blue, or green forms a pixel for color display.

2. Manufacturing PDP 1

2-1. Manufacturing Front Plate 2

As shown in FIG. 2, scan electrodes 4, sustain electrodes 5, and light-shielding layers 7 are formed on front glass substrate 3. Scan electrodes 4 and sustain electrodes 5 constitute display electrodes 6. To obtain conductivity, scan electrode 4 and sustain electrode 5 have silver (Ag)-contained white electrodes 4b and 5b, respectively. In addition, to improve contrast in display image, scan electrode 4 and sustain electrode 5 have black electrodes 4a and 5a containing black pigment, respectively. White electrode 4b is disposed on black electrode 4a, and similarly, white electrode 5b is disposed on black electrode 5a.

To be specific, first, a black paste layer (not shown) is formed on front glass substrate 3 by applying black paste containing black pigment onto front glass substrate 3 by screen printing. The black paste layer undergoes patterning by a photolithography method. Next, a white paste layer (not shown) is formed on the black paste layer by applying white paste containing silver (Ag) onto the black paste layer by screen printing. The white paste layer and the black paste layer undergo patterning by a photolithography method. After that, the white paste layer and the black paste layer undergo a developing process, and then they are baked. White electrodes 4b, 5b and black electrodes 4a, 5a as the components of display electrode 6 and light-shielding layer 7 are thus completed.

Next, a dielectric paste layer (not shown) is formed on front glass substrate 3 by applying dielectric paste onto substrate 3 so as to cover scan electrodes 4, sustain electrodes 5, and light-shielding layers 7 by, for example, die-coating. After a lapse of time required for leveling, the dielectric paste layer has a flat surface. After that, the dielectric paste layer is baked. Dielectric layer 8 is thus formed so as to cover scan electrodes 4, sustain electrodes 5, and light-shielding layers 7. The dielectric paste is a coating material containing dielectric glass, such as glass powder, a binder, and a solvent.

Next, on dielectric layer 8, protective layer 9 made of magnesium oxide (MgO) is formed by vacuum deposition. Through the processes above, scan electrodes 4, sustain electrodes 5, light-shielding layers 7, dielectric layer 8, and protective layer 9 are formed on front glass substrate 3. Front plate 2 is thus completed.

2-2. Manufacturing Rear Plate 10

Rear plate 10 shown in FIG. 1 is manufactured through the following processes.

First, address electrodes 12 are formed on rear glass substrate 11. Specifically, an address-electrode paste layer (not shown) is formed by applying silver (Ag)-contained paste onto rear glass substrate 11 by screen printing. Next, the address-electrode paste layer undergoes patterning by a photolithography method, by which a material layer (not shown) as a constituent of address electrode 12 is formed. After that, the material layer is baked at a predetermined temperature. Address electrodes 12 are thus completed. In the description above, screen printing is employed for forming the address electrodes on rear glass substrate 11, but it is not limited to. A metal film may be formed on substrate 11 by sputtering or vapor deposition.

After address electrodes 12 have been formed on rear glass substrate 11, a dielectric base paste layer (not shown) is formed by applying dielectric base paste onto substrate 11 by die-coating so as to cover address electrodes 12. The dielectric base paste layer is then baked, so that dielectric base layer 13 is completed. The dielectric base paste is a coating material containing dielectric base material, such as glass powder, a binder, and a solvent.

Next, a barrier-rib paste layer (not shown) is formed by applying a barrier-rib forming paste containing material of the barrier rib onto dielectric base layer 13. The barrier-rib paste layer undergoes patterning by a photolithography method, by which a constituent (not shown) of the material layer of barrier rib 14 is formed. The constituent is then baked. Through the processes above, barrier rib 14 is completed. Instead the photolithography method, sandblasting may be employed for patterning the barrier-rib paste layer applied to dielectric base layer 13.

Next, phosphor paste containing phosphor material is applied to dielectric base layer 13 between adjacent barrier ribs 14 and side surfaces of barrier ribs 14. The phosphor paste is then baked. Phosphor layer 15 is thus completed.

Through the processes above, predetermined components are formed on rear glass substrate 11, by which rear plate 10 is completed.

2-3. Assembling Front Plate 2 and Rear Plate 10

First, front plate 2 and rear plate 10 are oppositely positioned in a manner that display electrodes 6 are located orthogonal to address electrodes 12, and then the two plates are sealed at the peripheries with glass frit. Next, discharge space 16 is filled with discharge gas of, for example, Ne and Xe. PDP 1 is thus completed.

3. Details on Dielectric Layer 8

Dielectric layer 8 has to meet the need of having high breakdown voltage and high rate of light transmission. These characteristics largely depend on the composition of dielectric glass contained in dielectric layer 8.

3-1. Forming Dielectric Layer 8

Screen printing and die-coating is well known for forming dielectric layer 8. Dielectric paste is prepared for the material of dielectric layer 8. The dielectric paste contains dielectric glass powders, a solvent having resin, a plasticizer, and a binder. The dielectric paste is applied to front glass substrate 3 and then dried. After that, the dielectric paste is baked at a temperature ranging from 450° C. to 600° C., more preferably, from 550° C. to 590° C. Through the processes above, dielectric layer 8 formed of dielectric glass is completed. Dielectric layer 8 can also be formed by the following method. First, dielectric paste is applied to a film and then dried to obtain paste formed into a sheet. Next, the dielectric paste sheet is transferred to front glass substrate 3. After that, the dielectric paste sheet is baked at a temperature ranging from 450° C. to 600° C., more preferably, from 550° C. to 590° C. Through the processes above, dielectric layer 8 formed of dielectric glass is completed.

As the thickness of dielectric layer 8 decreases, PDP 1 has increase in brightness; at the same time, PDP 1 has decrease in discharge voltage. It is therefore preferable that the thickness of dielectric layer 8 should be minimized without decrease in breakdown voltage. According to the present embodiment, to maintain both of breakdown voltage and visible-light transmittance at a sufficient level, dielectric layer 8 has a thickness ranging from 15 μm to 41 μm.

3-2. Composition of Dielectric Glass

Dielectric glass has conventionally contained lead oxide of 20 wt % or more so as to stand high-temperature baking ranging from 450° C. to 600° C. However, for environmental protection, the dielectric glass of the present embodiment contains no lead oxide, that is, dielectric layer 8 is free from lead oxide.

Dielectric layer 8 of the present embodiment contains an oxide of a divalent element, an oxide of a trivalent element, and an oxide of a tetravalent element. The content ratio by weight of the oxides above is determined so that the total content of the oxide of a trivalent element and the oxide of a tetravalent element is greater than the content of the oxide of a divalent element. Hereinafter, content ratio by weight is simply referred to content.

In the description above, an “n-valent” element represents an element having a maximum oxidation number of n. That is, a divalent element has a maximum oxidation number of 2.

The number of bridging oxygen atoms of an oxide in dielectric glass depends on the electron structure of an oxidizable element forming the oxide. According to the dielectric glass of the present embodiment, increase in the number of bridging oxygen atoms enhances rigidity of the bridge structure, allowing dielectric layer 8 to have high fracture toughness. This suppresses the occurrence of cracks in dielectric layer 8.

According to the present embodiment, it is preferable that dielectric layer 8 contains an oxide of a tetravalent element, an oxide of a trivalent element, and an oxide of a divalent element in descending order of content. The composition further increases the number of bridging oxygen atoms in dielectric glass, enhancing the fracture toughness of dielectric layer 8.

Further, according to the present embodiment, as an example, dielectric layer 8 preferably contains an oxide of a tetravalent element larger in content than an oxide of a divalent element; more preferably, contains an oxide of a tetravalent element not less than 20 wt % and not more than 40 wt % and an oxide of a divalent element not less than 10 wt % and less than 20 wt %.

If dielectric layer 8 contains an oxide of a divalent element of 20 wt % or more and an oxide of a tetravalent element less than 20 wt %, the dielectric layer reduces the effect that suppresses the occurrence of cracks. Increase in content of an oxide of a tetravalent element enhances the suppressing effect. However, if dielectric layer 8 contains an oxide of a divalent element less than 10 wt % and an oxide of a tetravalent element of 40 wt % or more, the softening point of the dielectric glass gets higher, increasing the baking temperature of the dielectric paste.

According to the present embodiment, as an example, dielectric layer 8 contains no calcium oxide (CaO). CaO has a large crystal structure, degrading transmittance of dielectric glass. As an example in the present embodiment, dielectric layer 8 contains diboron trioxide (B₂O₃), which will be described later. Employing B₂O₃, instead of CaO, enhances transmittance of dielectric glass.

According to the present embodiment, as an example, dielectric layer 8 contains diboron trioxide (B₂O₃) and silicon dioxide (SiO₂. Specifically, the total content of B₂O₃ and SiO₂ is not less than 45 wt % and not more than 65 wt %; more preferably, SiO₂ is larger in content than B₂O₃. The oxide of a tetravalent element (i.e. SiO₂) and the oxide of a trivalent element (i.e. B₂O₃) form dielectric glass having a bridge structure. In addition, dielectric layer 8 contains SiO₂ more than B₂O₃ in content. This means increase in number of bridging oxygen atoms per oxide of dielectric glass. According to the dielectric glass of the present embodiment, increase in number of bridging oxygen atoms enhances rigidity of the bridge structure, allowing dielectric layer 8 to have high fracture toughness. This suppresses the occurrence of cracks in dielectric layer 8.

A composition with a total content of SiO₂ and B₂O₃ less than 45 wt % reduces the effect that suppresses the occurrence of cracks. In contrast, if the total content of SiO₂ and B₂O₃ is greater than 65 wt %, the softening point of the dielectric glass gets higher, increasing the baking temperature of the dielectric paste.

Dielectric layer 8 of the present embodiment contains an oxide of a tetravalent element, for example, SiO₂. Compared to an oxide of a divalent element, an oxide of a tetravalent element has an effect that suppresses the occurrence of cracks in dielectric layer 8; on the other hand, the oxide of a tetravalent element increases the softening point of dielectric glass. That is, the oxide of a tetravalent element contributes to increase in baking temperature of dielectric paste.

It is a conventional knowledge that an alkali metal oxide suppresses the increase in softening point of dielectric glass. However, if dielectric layer 8 contains an alkali metal oxide, such as potassium oxide (K₂O), lithium oxide (Li₂O) and sodium oxide (Na₂O), distortion occurs in front glass substrate 3. Specifically, difference in amount of distortion occurs between the following two areas: the area where dielectric layer 8 makes contact with transparent electrodes 4a, 5a and the area where dielectric layer 8 makes contact with a part—on which no pattern is formed—of front glass substrate 3. As a result, distortion is distributed all over front glass substrate 3. The distributed distortion contributes to impaired strength of front glass substrate 3.

According to the present embodiment, as an example, dielectric layer 8 contains K₂O and at least any one of Li₂O and Na₂O. Preferably, the total of the content of K₂O and the content of at least any one of Li₂O and Na₂O is not less than 3 wt % and not more than 10 wt %; more preferably, the K₂O content ratio to the total of the K₂O content and the content of at least any one of Li₂O and Na₂O is not less than 70% and not more than 90%.

The structure of the present embodiment suppresses the distortion distributed over front glass substrate 3. If the total of the K₂O content and the content of at least any one of Li₂O and Na₂O is less than 3 wt %, the effect that suppresses the distribution of distortion in front glass substrate 3 reduces. In contrast, if the total of the K₂O content and the content of at least any one of Li₂O and Na₂O exceed 10 wt %, front glass substrate 3 disposed beneath dielectric layer 8 has a tensile stress. This can be another cause of degrading the strength of front glass substrate 3.

If the K₂O content ratio to the total content above is less than 70%, the effect that suppresses the distribution of distortion in front glass substrate 3 reduces. In contrast, if the content ratio of K₂O to the total content exceeds 90%, the coefficient of thermal expansion of dielectric layer 8 increases, resulting in inconsistency of coefficient of thermal expansion between front glass substrate 3 and dielectric layer 8.

3-3. Manufacturing Dielectric Paste

First, dielectric material powder is prepared. Specifically, dielectric material having composition described above is ground by a wet jet mill or a ball mill so as to have an average particle diameter of 0.5- 3.0 μm. Next, the dielectric material powder of 50-65 wt % and a binder component of 35-50 wt % are mixed well by a triple roll mill. In this way, dielectric layer paste to be processed by die-coating or printing is prepared.

As for the binder component, ethylcellulose, or terpineol or butyl carbitol acetate containing acrylic resin of 1-20 wt % can be employed. The dielectric paste may contain the following substances: as for plasticizers, dioctyl phthalate, dibutyl phthalate, triphenyl phosphate, and tributyl phosphate; as for dispersants, glycerol monoolate, sorbitan sesquioleate, HOMOGENOL (made by Kao Corporation), and ester phosphate of an alkyl aryl group. The dielectric paste having compositions above enhances printing performance.

4. Experimental PDP

Performance evaluation has been carried out on an experimental PDP having a structure conforming to a 42-inch class high definition TV. Specifically, the PDP has the front plate and the rear plate. The two plates are oppositely disposed and sealed at the peripheries. The front plate has the display electrodes and the dielectric layer. The barrier ribs of the PDP have a height of 0.15 mm and a barrier-rib interval (i.e. cell pitch) of 0.15 mm. The interval between the electrodes of each display electrode measures 0.06 mm. The discharge space is filled with Neon (Ne)-Xenon (Xe) mixture gas (having a Xenon-content of 15% by volume) with an inner pressure of 60 kPa.

Table 1

Table 1 shows the composition of the dielectric glass employed for the dielectric layer of the PDP. In Table 1, “other materials” refer to lead-free material composition, for example, aluminum oxide (Al₂O₃) and bismuth oxide (Bi₂O₃). The lead-free material composition has no limitation in amount of content.

4-1. Evaluation on Fracture Toughness

The dielectric layer of each sample has been tested for fracture toughness that represents internal strength of dielectric glass. The measurement device used here is a dynamic ultra microhardness tester, DUH-201 made by Shimadzu Corporation. The fracture toughness is evaluated by a rate of occurrence of cracks in the dielectric layer. In the test, an indenter of triangular pyramid of the hardness tester is pressed on the surface of the dielectric layer so as to leave an indentation on the surface. The indentation can develop into a crack. The crack occurrence rate is determined by the number of samples with cracks to the total number of the samples. The crack occurrence rate relates to brittleness of dielectric glass. That is, the lower the crack occurrence rate, the higher the toughness of dielectric glass.

Experimental sample 1 shown in Table 1 contains zinc oxide (ZnO) as an oxide of a divalent element, B₂O₃ as an oxide of a trivalent element, SiO₂ and zirconium dioxide (ZrO₂) as an oxide of a tetravalent element. The content of ZnO is 17.9 wt %, whereas the total content of B₂O₃, SiO₂, and ZrO₂ amounts to 54.4 wt %. That is, the total content of the oxide of a trivalent element and the oxide of a tetravalent element is greater than the content of the oxide of a divalent element. Besides, the content of ZnO is 17.9 wt %, whereas the total content of SiO₂ and ZrO₂ is 25.8 wt %. That is, the content of the oxide of a tetravalent element is greater than that of the oxide of a divalent element. Experimental sample 1 has a crack occurrence rate of 16.7%.

Experimental sample 2 shown in Table 1 contains ZnO as an oxide of a divalent element, B₂O₃ as an oxide of a trivalent element, SiO₂ and ZrO₂ as an oxide of a tetravalent element. The content of ZnO is 12.7 wt %, whereas the total content of B₂O₃, SiO₂, and ZrO₂ amounts to 56.3 wt %. That is, the total content of the oxide of a trivalent element and the oxide of a tetravalent element is greater than the content of the oxide of a divalent element. Besides, the content of ZnO is 12.7 wt %, whereas the content of B₂O₃ is 25.4 wt %. The total content of SiO₂ and ZrO₂ is 30.9 wt %. That is, the content of the oxide of a trivalent element is greater than that of the oxide of a divalent element, and the content of the oxide of a tetravalent element is greater than that of the oxide of a trivalent element. Further, as described above, the content of ZnO is 12.7 wt %, whereas the total content of SiO₂ and ZrO₂ is 30.9 wt %. That is, the content of the oxide of a tetravalent element is greater than that of the oxide of a divalent element. Experimental sample 2 has a crack occurrence rate of 16.7%.

Comparative sample 1 shown in Table 1 contains barium oxide (BaO) and ZnO as an oxide of a divalent element, B₂O₃ as an oxide of a trivalent element, and SiO₂ as an oxide of a tetravalent element. The total content of BaO and ZnO is 56.9 wt %, whereas the total content of B₂O₃ and SiO₂ is 21.4 wt %. That is, the total content of the oxide of a trivalent element and the oxide of a tetravalent element is smaller than the content of the oxide of a divalent element. Comparative sample 1 has a crack occurrence rate of 100%.

Comparative sample 2 shown in Table 1 contains BaO and ZnO as an oxide of a divalent element, B₂O₃ as an oxide of a trivalent element, and SiO₂ and ZrO₂ as an oxide of a tetravalent element. The total content of BaO and ZnO is 50.2 wt %, whereas the total content of B₂O₃, SiO₂, and ZrO₂ is 26.4 wt %. That is, the total content of the oxide of a trivalent element and the oxide of a tetravalent element is smaller than the content of the oxide of a divalent element. Comparative sample 2 has a crack occurrence rate of 100%.

Comparative samples 1 and 2 contain an oxide of a divalent element not less than 20 wt % and an oxide of a tetravalent element less than 20 wt %.

Table 1 shows the good results of experimental samples 1 and 2; the crack occurrence rate of them is much below, compared to comparative samples 1 and 2.

Besides, according to experimental samples 1 and 2, the content of an oxide of a divalent element is not less than 10 wt % and less than 20 wt %, and the content of an oxide of a tetravalent element is not less than 20 wt % and not more than 40 wt %. Such determined content allows experimental samples 1 and 2 to have further decrease in crack occurrence rate.

Although Table 1 does not show, a composition that contains an oxide of a divalent element less than 10 wt % and an oxide of a tetravalent element more than 40 wt % increases the softening point of glass.

4-2. Evaluation on Impact Resistance

Each sample has been tested, by a steel-ball drop tester, for impact resistance of dielectric glass, i.e., strength against an impact from outside. In the test, the PDP is horizontally located with the front plate faced upward. Next, a steel ball that weighs 500 g is set at a predetermined height of the tester, and then dropped onto the PDP. When the PDP has no breakage, the steel ball is set at a higher position and dropped again. A height at which the steel ball is set when the PDP has breakage is measured as the test value. Table 1 shows each result as a relative value to the result of comparative sample 2 determined as a reference value of 1. A greater value means that the PDP has been withstanding the impact of the ball set at higher. That is, the greater the value is, the higher the impact resistance of the PDP.

Experimental sample 1 contains B₂O₃ and SiO₂. The total content of B₂O₃ and SiO₂ amounts 54.3 wt %; the total content is not less than 45 wt % and not more than 65 wt %. The result of the drop test of experimental sample 1 is 1.5.

Experimental sample 2 contains B₂O₃ and SiO₂. The total content of B₂O₃ and SiO₂ amounts 56.0 wt %; the total content is not less than 45 wt % and not more than 65 wt %. The result of the drop test of experimental sample 2 is 1.8.

In contrast, comparative sample 1 contains B₂O₃ and SiO₂. The total content of B₂O₃ and SiO₂ amounts 21.4 wt %; the total content is out of the range between 45 wt % and 65 wt %. The result of the drop test of comparative sample 1 is 0.7.

Similarly, comparative sample 2 contains B₂O₃ and SiO₂. The total content of B₂O₃ and SiO₂ amounts 26.4 wt %; the total content is out of the range between 45 wt % and 65 wt %. The result of the drop test of comparative sample 1 is 1 (as the reference value).

As described above, experimental samples 1 and 2 have test values greater than those of comparative samples 1 and 2, and have achieved good results.

4-3. Evaluation on Distortion

Each sample has been tested for distortion in the front grass substrate by a polarimeter: Polarimeter SF2 made by Shinko Seiki Co. Ltd. Using polarized light, the polarimeter determines condition and a degree of distortion from a phase difference between two lights that occurs when light passes through an object having a distortion. Besides, if a residual stress remains in front glass substrate 3, the substrate has a distortion. The polarimeter can find presence or absence of residual stress in the front glass substrate. The measurement result of residual stress is provided as follows. If a compressive stress remains in the front glass substrate, the measurement result is given as a positive (+) value, whereas if a tensile stress remains in the substrate, the measurement result is given as a negative (−) value. If the result is determined as a positive value (that represents the presence of a compressive stress in the front glass substrate), the dielectric layer has a tensile stress. This easily causes a crack in the dielectric layer, degrading the strength of the dielectric layer. It is therefore preferable that the measurement result has a negative (−) value.

In Table 1, “stress at net glass section” represents a residual stress measured at a part of the front glass substrate that directly makes contact with the dielectric layer, that is, a part of the substrate with no pattern thereon. Similarly, “stress at transparent electrode section” in Table 1 represents a residual stress measured at a part of the dielectric layer that makes contact with a transparent electrode.

Experimental sample 2 contains K₂O and at least any one of Li₂O and Na₂O such that the total content of K₂O and at least any one of Li₂O and Na₂O is 9.4 wt %. Besides, the K₂O content ratio to the total content makes up 84.0%. That is, in experimental sample 2, the total content of K₂O and at least any one of Li₂O and Na₂O is not less than 3 wt % and not more than 10 wt %, and the K₂O content ratio to the total content is not less than 70% and not more than 90%. According to experimental sample 2, the measurement results of residual stress are as follows: stress at net glass section: −0.21 MPa; stress at transparent electrode section: −0.33 MPa; and difference in residual stress between two sections: 0.12 MPa.

In contrast, comparative sample 2 contains K₂O and at least any one of Li₂O and Na₂O such that the total content of K₂O and at least any one of Li₂O and Na₂O is 4.1 wt %. However, the K₂O content ratio to the total content is 63.4%, which is less than 70%. According to comparative sample 2, the measurement results of residual stress are as follows: stress at net glass section: −0.38 MPa; stress at transparent electrode section: −1.08 MPa; and difference in residual stress between two sections: 0.7 MPa.

From the measurement results above, experimental sample 2 has a difference in residual stress smaller than that of comparative sample 2. That is, experimental sample 2 is superior to comparative sample 2 in that the distribution of distortion is effectively suppressed.

### INDUSTRIAL APPLICABILITY

The present invention provides an environment-friendly PDP with high reliability. Such structured PDP is suitable for a display device having a large screen.

### REFERENCE MARKS IN THE DRAWINGS

1 PDP
2 front plate
3 front glass substrate
4 scan electrode
4a, 5a black electrode
4b, 5b white electrode
5 sustain electrode
6 display electrode
7 black stripe (light-shielding layer)
8 dielectric layer
9 protective layer
10 rear plate
11 rear glass substrate
12 address electrode
13 dielectric base layer
14 barrier rib
15 phosphor layer
16 discharge space

TABLE 1

| | | Experimental | Experimental | Comparative | Comparative |
|---|---|---|---|---|---|
| | | sample 1 | sample 2 | sample 1 | sample 2 |
| Divalent | BaO | — | — | 18.8 | 3.5 |
| | CaO | — | — | — | 3.9 |
| | ZnO | 17.9 | 12.7 | 38.1 | 42.8 |
| Trivalent | B₂O₃ | 28.6 | 25.4 | 14.3 | 17.5 |
| Tetravalent | SiO₂ | 25.7 | 30.6 | 7.1 | 8.9 |
| | ZrO₂ | 0.1 | 0.3 | — | 0.2 |

| | | | | |
|---|---|---|---|---|
| K₂O | 10.4 | 7.9 | — | 2.6 |
| Li₂O + Na₂O | 0.8 | 1.5 | — | 1.5 |
| Total of other materials | 16.5 | 21.6 | 21.7 | 19.1 |
| Total of divalent | 17.9 | 12.7 | 56.9 | 50.2 |
| Trivalent + tetravalent | 54.4 | 56.3 | 21.4 | 26.4 |
| Total of tetravalent | 25.8 | 30.9 | 7.1 | 9.1 |
| SiO₂ + B₂O₃ | 54.3 | 56 | 21.4 | 26.4 |
| K₂O + Li₂O + Na₂O | 11.2 | 9.4 | — | 4.1 |
| K₂O/K₂O + Li₂O + Na₂O | 92.9% | 84.0% | — | 63.4% |
| Softening point (° C.) | 577 | 585 | 580 | 577 |
| Crack occurrence rate (%) | 16.7 | 16.7 | 100 | 100 |
| Steel-ball drop test | 1.5 | 1.8 | 0.7 | 1 |
| Stress at net glass section (MPa) | −0.16 | −0.21 | — | −0.38 |
| Stress at transparent electrode | 0.98 | −0.33 | — | −1.08 |
| section (MPa) | | | | |
| Difference in stress | 1.14 | 0.12 | — | 0.7 |

unit or composition: wt %

1. A plasma display panel comprising:
a front plate further including a display electrode and a dielectric layer; and
a rear plate disposed opposite to the front plate and sealed to the front plate at peripheries,
wherein the dielectric layer contains an oxide of a divalent element, an oxide of a trivalent element, and an oxide of a tetravalent element, and
a total content of the oxide of the trivalent element and the oxide of the tetravalent element is larger by weight than a content of the oxide of the divalent element.

2. The plasma display panel of claim 1, wherein the dielectric layer contains the oxide of the tetravalent element, the oxide of the trivalent element, and the oxide of the divalent element in descending order of content by weight.

3. The plasma display panel of claim 1, wherein the dielectric layer has a content of the oxide of the tetravalent element larger by weight than a content of the oxide of the divalent element.

4. The plasma display panel of claim 3, wherein the dielectric layer has a content of the oxide of the divalent element not less than 10 wt % and less than 20 wt % and has a content of the oxide of the tetravalent element not less than 20 wt % and not more than 40 wt %.

5. The plasma display panel of claim 1, wherein the dielectric layer contains B₂O₃ and SiO₂, and a total of the B₂O₃ content and the SiO₂ content is not less than 45 wt % and not more than 65 wt %.

6. The plasma display panel of claim 2, wherein the dielectric layer contains B₂O₃ and SiO₂, and the SiO₂ content is larger by weight than the B₂O₃ content.

7. The plasma display panel of claim 1, wherein the dielectric layer contains K₂O and at least any one of Li₂O and Na₂O, a total of the K₂O content and at least any one of the Li₂O content and the Na₂O content is not less than 3 wt % and not more than 10 wt %, and the K₂O content ratio to a total of the K₂O content and at least any one of the Li₂O content and the Na₂O content is not less than 70% and not more than 90%.

8. The plasma display panel of claim 2, wherein the dielectric layer contains K₂O and at least any one of Li₂O and Na₂O, a total of the K₂O content and at least any one of the Li₂O content and the Na₂O content is not less than 3 wt % and not more than 10 wt %, and the K₂O content ratio to a total of the K₂O content and at least any one of the Li₂O content and the Na₂O content is not less than 70% and not more than 90%.

9. The plasma display panel of claim 3, wherein the dielectric layer contains K₂O and at least any one of Li₂O and Na₂O, a total of the K₂O content and at least any one of the Li₂O content and the Na₂O content is not less than 3 wt % and not more than 10 wt %, and the K₂O content ratio to a total of the K₂O content and at least any one of the Li₂O content and the Na₂O content is not less than 70% and not more than 90%.
